(19) United States
(12) Patent Application Publication
(10) Pub. No.: US 2003/0117380 A1
(43) Pub. Date: Jun. 26, 2003

(54) Method of inputting a numerical value using a touch panel and input apparatus thereof

(75) Inventor: Eisuke Kanzaki, Fujisawa-shi (JP)

Correspondence Address: Ryan, Mason & Lewis, LLP, Suite 205, 1300 Post Road, Fairfield, CT, 06430, US

(73) Assignee: International Business Machines Corporation, Armonk, NY

(21) Appl. No.: 10/354,211

(22) Filed: Jan. 28, 2003

Related U.S. Application Data
(63) Continuation of application No. 09/526,987, filed on Mar. 16, 2000.

(30) Foreign Application Priority Data
Mar. 16, 1999 (JP) 11-070207

(51) Int. Cl. G09G 5/00

(52) U.S. Cl. 345/173

(57) ABSTRACT

A numerical value input method and input apparatus are disclosed using a touch panel, permitting the determination of the numerical value to be inputted by a unit executing an application without having to use a separate input apparatus. A virtual input device picture, preferably a dial picture, is displayed on a display screen with a touch input function. Then a finger or a pen is moved in a state of contact on the displayed virtual dial picture. By thus moving a finger or a pen on the virtual dial picture, the numerical value to be inputted is determined. Numerical values can be thereby inputted with only a display unit, without using any separate unit of hardware, such as a jog dial or a dial box. In this context, the numerical value means a concept including both an increment/decrement and a continuous value.

### CROSS REFERENCE TO RELATED APPLICATION

This application is a continuation of U.S. patent application Ser. No. 09/526,987, filed on Mar. 16, 2000. This application claims the benefit of a Japanese Patent Application Serial Number 11-070207, filed on Mar. 16, 1999.

### FIELD OF THE INVENTION

The present invention is intended to provide a numerical value input method and input apparatus using a touch panel, capable of numerical value inputting such as required in Computer Aided Design (CAD), for example.

### BACKGROUND OF THE INVENTION

Apparatuses for inputting continuous values include input apparatus using a dial. To cite examples of them, there are a jog dial or wheel for moving a scroll bar, and a dial box used in CADAM or CATIA (both names of specific CAD program products).

FIG. 4 is a diagram illustrating the configuration of one example of a dial box, which has been known as a numerical value input apparatus according to the prior art. In the example shown in FIG. 4, a dial box body 51 is configured separately from a personal computer (not shown) executing, for instance, CAD software to which numerical values are to be inputted, and connection to such a personal computer is accomplished with a cable 52. The body 51 is provided with eight rotary dials 53-1 to 53-8. To each of the rotary dials 53-1 to 53-8 is allocated inputting of various numerical values required when the CAD software is executed. A side of each of the rotary dials 53-1 to 53-8 slightly projects outward from the body 51. By turning this projecting part with, for instance, a finger, numerical values can be inputted.

The kind of input apparatus referred to above is not usually provided on the display unit of a personal computer executing application software. Consequently, there was a need to manufacture an input apparatus as a unit of hardware separate from the display unit body, and at the same time there was a need to newly purchase such an input apparatus. Furthermore, a dial box, of which one example is illustrated in FIG. 4, was a large hardware unit, requiring a special installation space.

On the other hand, techniques using a display unit provided with a touch input apparatus to move the displayed image or provide image displays from varied points of view by contact and movement with a finger or a pen on the display unit are proposed in, e.g., Published Unexamined Patent Application No. 6-149531 and Published Unexamined Patent Application No. 9-134269. However, none of these techniques were designed to input numerical values by touch inputting, and they could not be used as they were for numerical value inputting as envisaged in the present invention.

An object of the invention is to solve the above-noted problem, and to provide a numerical value input method and input apparatus using a touch panel, permitting the determination of the numerical value to be inputted by the unit executing an application without having to use a separate input apparatus.

### SUMMARY OF THE INVENTION

A method of inputting a numerical value using a touch panel is disclosed according to the present invention. First, a virtual input device picture, preferably a dial picture, is displayed on a display screen with a touch input function. Then a finger or a pen is moved in a state of contact on the displayed virtual input device picture. By moving the finger or the pen on the virtual input device picture, the numerical value to be inputted is determined. In the context of the invention, the numerical value means a concept including both an increment/decrement, resulting from the resetting of input values until immediately before and inputting the input value of only the current round, and a continuous value resulting from the addition of the input value of the current round to the input values until immediately before.

According to the method of inputting a numerical value using a touch panel according to the present invention, by providing a touch input function, for instance, to the display unit of a personal computer executing an application needing the inputting of numerical values and enabling numerical values to be inputted utilizing a virtual input device picture displayed on that display unit, numerical values can be inputted with only the display unit, without using any separate unit of hardware, such as a jog dial or a dial box.

A preferred mode of carrying out the invention is configured so as to determine the numerical value to be inputted from the moving distance or moving speed of a finger or a pen on the virtual dial picture. Further, the moving distance and the moving speed are calculated from the total sum of distances over which the finger or the pen moved in a state of contact in a certain length of time within the dial area of the virtual dial picture. In another preferred example, light or sound may be emitted, while the finger or the pen is moved in a state of contact on the virtual dial picture, according to the operating speed to give the user the feel of actually operating the dial. Alternatively, the display mode of the virtual dial picture is configured to permit selection out of a constant display mode, an on-demand display mode, and a display mode for automatic activation only when that input is needed.

An apparatus for inputting a numerical value according to the invention, in order to realize the above-described input method, comprises a display unit with a touch input function, a driver and a control unit. The display unit displays a virtual dial picture and, at the same time, determines as touch input the positional information on the finger or the pen moved in a state of contact on the virtual dial picture. The driver, utilizing the clock of a timer, determines the movement information on dial operation from the positional infonnation obtained from the touch input on the display unit. Preferably, this movement information should comprise the movement start position, moving distance, moving speed and moving direction of the finger or the pen on the virtual dial. The control unit determines the numerical value to be inputted according to the movement information obtained by the driver.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating one example of a screen display in a numerical value input method using a touch panel according to the invention.

FIG. 2 is a diagram illustrating another example of a screen display by the method of inputting numerical values using a touch panel according to the invention.

FIG. 3 is a block diagram illustrating the configuration of one example of a numerical value input apparatus using a touch panel according to the invention.

FIG. 4 is a diagram illustrating the configuration of one example of a dial box according to the prior art.

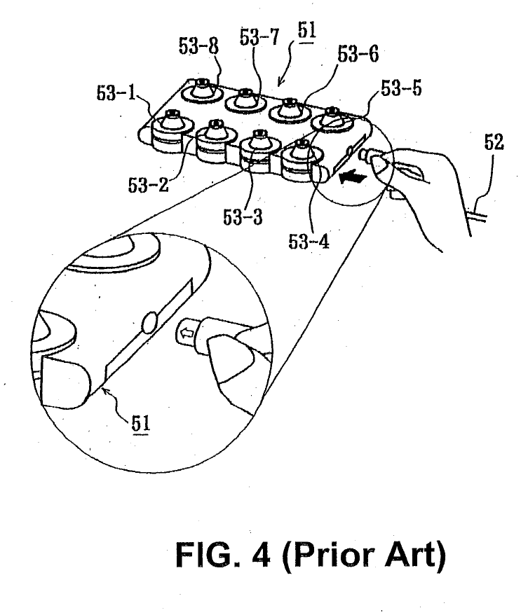

### DETAILED DESCRIPTION OF PREFERRED EMBODIMENTS

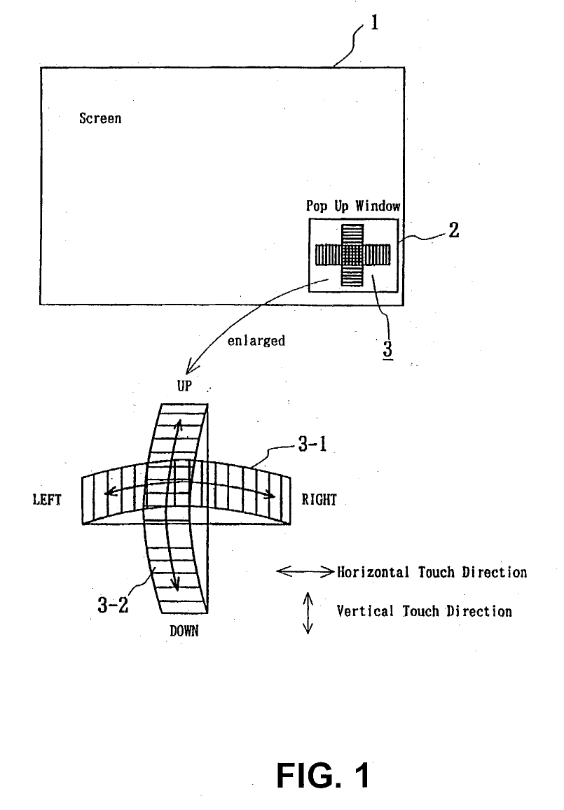

FIG. 1 is a diagram illustrating an example of a screen display 1 in a numerical value input method using a touch panel according to the invention. In the example shown in FIG. 1, a rectangular pop-up window 2 is displayed in the bottom right corner of a display screen 1 with a touch input function, and a jog dial 3 is displayed in this pop-up window 2. The jog dial 3 comprises a horizontally turning dial picture 3-1 for inputting in the horizontal direction and a vertically turning dial picture 3-2 for inputting in the vertical direction.

Numerical value inputting with a finger or a pen is accomplished in the following manner. First, as shown in FIG. 1, a jog dial 3 is displayed in the pop-up window 2 on the display screen 1 with a touch input function, and the virtual dial pictures 3-1 and 3-2 are displayed. Then, a finger or a pen is moved in a contact state on the dial picture 3-1 or 3-2. In this process, the quantity of movement, for instance, in the X direction (horizontal direction) or the Y direction (the vertical direction) on the display screen 1 is determined from the position touched by the finger or the pen, i.e. whether the dial picture 3-1 or 3-2 in the example of FIG. 1, and the start position or the end position of the touch or a preset position. And the numerical value to be inputted is calculated from the quantity of movement in the X direction or Y direction that has been determined.

Next, the method of calculating the numerical value to be inputted from the quantity of movement in the X direction or the Y direction will be described. Incidentally, as the quantity of movement is calculated in the same way for both the X direction and the Y direction, the following description will make no distinction between the X direction and the Y direction, but the quantity of movement in a certain direction will be referred to.

By a first method, the numerical value to be inputted is calculated according to the quantity of movement determined on the virtual dial picture 3 as described above. Thus, the numerical value is increased or decreased according to the relative magnitude of the quantity of movement determined. For instance, if the quantity of movement is large, the numerical value will be increased, or if the quantity of movement is small, the numerical value will be decreased. Further, since it will take a long time, or be impossible, to acquire touch information unless the time interval of touch information acquisition is determined, it is preferable, in determining the moving distance, to determine it as the moving distance in a state of contact of a finger or a pen over a prescribed area in a certain length of time. The length of time is determined as desired according to the object. Or it is conceivable that the user stops touching within that certain length of time, for instance, he or she may tap the dial picture 3-1 or 3-2 with the finger or the pen. In such a case, it is preferable to determine the moving distance as the total sum of distances over which the finger or the pen moved in a state of contact.

Next, by a second method, the numerical value to be inputted is calculated according to the moving speed determined from the quantity of movement obtained on the virtual dial picture 3 as described above. Here the moving speed can be calculated by dividing the total sum of distances over which the finger or the pen moved in a state of contact in a certain length of time within a prescribed area by that certain length of time. And the numerical value is increased or decreased according to the moving speed that has been determined. For instance, if the moving speed is high, the numerical value will be increased, or if the moving speed is low, the numerical value will be decreased. By calculating the numerical value as described above, the user can be caused to feel as if operating a real dial.

In addition, though not referred to in the foregoing description, to give the user, when he or she is operating the dial by moving a finger or a pen in a state of contact on the virtual dial picture 3, the feel of actually operating the dial, light or sound may be emitted according to the operating speed. Further, the apparatus may as well be configured to select the display mode of the virtual dial picture 3 out of a constant display mode, an on-demand display mode, and a display mode for automatic activation only when that input is needed.

According to the invention, a similar feel to what is obtained from the track ball used for moving the cursor in some laptop personal computers can be obtained. A track ball is so configured that the quantity of its rotation substantially corresponds to the quantity of movement of the cursor. However, when it is turned at high speed, the track ball not only moves while it is being turned by a finger but continues to turn by inertia after the finger is let go off the track ball. Therefore, if the track ball is moved at high speed, the cursor will move more than the track ball was turned by the finger. The numerical value input apparatus according to the present invention, as it inputs numerical value according the moving speed, a feel of operation resembling that of the track ball can be realized on the touch panel. Thus, the input apparatus according to the invention can also realize a similar feel of operation to that of an existing input apparatus. In such a case, if the input apparatus according to the invention is displayed on the touch panel in a similar appearance to the pertinent input apparatus, the feel of operation will be further improved. Thus, the input apparatus according to the invention may use displaying in the appearance of a dial, track bail, or any other shape.

Also, according to the invention, the correlation between the moving speed and the inputted numerical value may be either a linear or a non-linear one. By designing so that the inputted numerical values increase exponentially as the moving speed rises, the numerical value, whether large or small, can be inputted very easily. Further, according to the invention, a filtering function may be provided. The filtering function means setting so that, even if very high speed inputting occurs abruptly, a small numerical value be inputted first. Even if a very large value is to be inputted, usually the dial is turned slowly at first, and the turning speed is gradually raised upward. Abrupt occurrence of very high speed inputting is less likely to be intentional than inputting of a large value resulting from touching the input apparatus by mistake. Therefore, such a filtering function is useful.

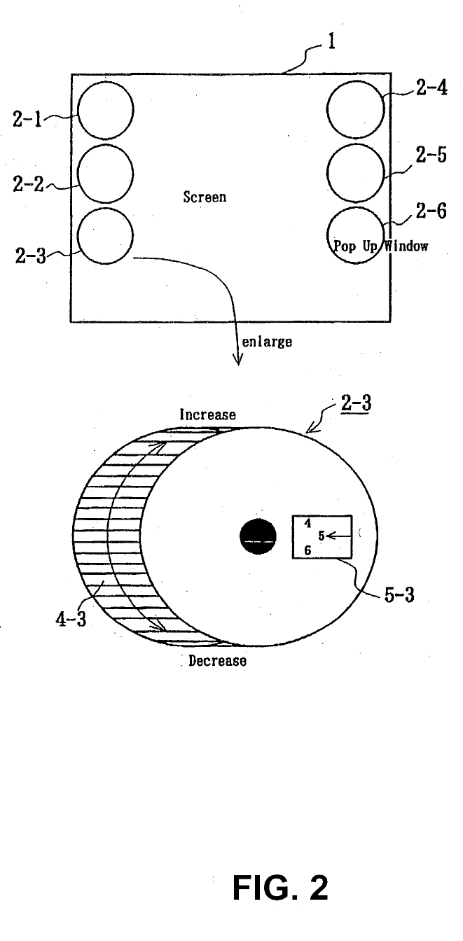

FIG. 2 is a diagram illustrating another example of a screen display by the method of inputting numerical values using a touch panel according to the present invention. In the example shown in FIG. 2, a dial box is configured by displaying a total of six pop-up windows 2-1 to 2-6, consisting, for example, of three each in the left end part and the right end part of the display screen 1 with a touch input function and further displaying rotary dials 4-1 to 4-6 in each of the pop-up windows 2-1 to 2-6. This example is configured to provide in each of the pop-up windows 2-1 to 2-6 numerical value display windows 5-1 to 5-6 besides the rotary dials 4-1 to 4-6 so that the current numerical values can be numerically displayed. In the example shown in FIG. 2, numerical value inputting with a finger or a pen is similar to the example described above with reference to FIG. 1. Thus, the turning direction of the rotary dial 4-3 can be determined from the position touched, the start position of the touch and the end position of the touch. The values that are read are sampled at regular intervals of time counted by a timer, and the moving speed is calculated on the basis of the moving distance and the duration of the movement. It is the same as in the foregoing example that both the moving distance and the moving speed can be used to figure out numerical values.

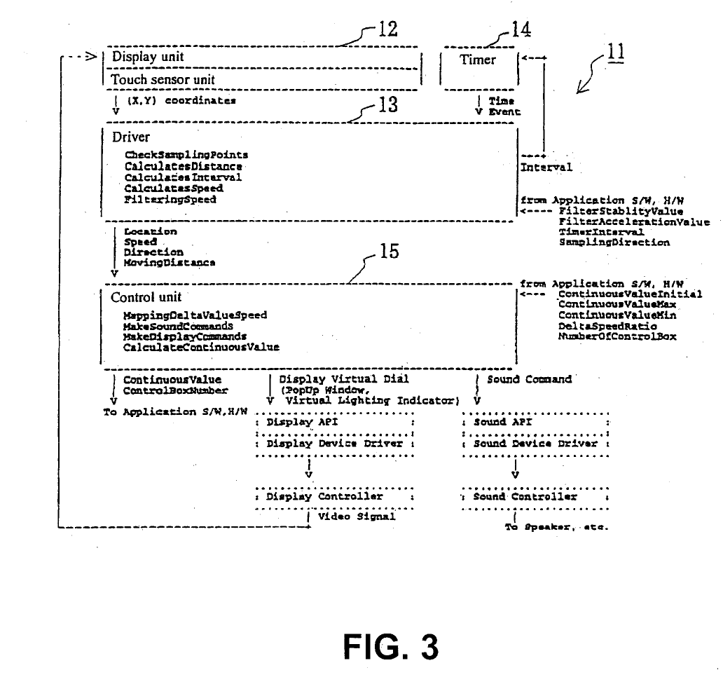

FIG. 3 is a block diagram illustrating the configuration of one example of a numerical value input apparatus using a touch panel according to the present invention. In the example shown in FIG. 3, a numerical value input apparatus 11 according to the invention comprises a display unit 12 with a touch input function, a driver 13, a timer 14 and a control unit 15. On the display unit 12 is displayed a virtual dial picture, and positional information is obtained from the position of a finger or a pen in a state of contact with a virtual dial picture as touch input. The positional information is supplied to the driver 13. The driver 13, using the clock of the timer 14, obtains the movement information of dial operation from the positional information from the touch input on the display unit 12. An example of movement information comprises the moving start position of the finger or the pen on the virtual dial picture, its moving distance, moving speed and moving direction. The movement information is supplied to the control unit 15. The control unit 15 determines the numerical value to be inputted according to the movement information obtained by the driver 13. The determined numerical value is obtained upon request, for instance, at the time of executing application software, and a numerical value obtained in response to that request on the basis for various parameters from the application is outputted to the application software. The obtained numerical value is also supplied to controllers for light and sound. Alternatively, the obtained numerical value may as well be handed over as a direct input value to the hardware. Further, the obtained numerical value is also supplied to the numerical value display windows 5-1 to 5-6 in FIG. 2, and used for displaying the current numerical value.

In the example illustrated in FIG. 3, the driver 13 checks whether the position indicated by “CheckSamplingPoints” is valid, and changes an abrupt change in speed into a gradual change by calculating the distance of movement at “CalculatesDistance,” calculating the time taken at “Calculateslnterval,” calculating the speed at “CalculatesSpeed,” and filtering the speed at “FilteringSpeed.” Further, the control unit 15 allocates the speed into an increment/decrement at “MappingDeltaSpeed,” issues sound which is varied according to the magnitude of the increment/decrement at “MakeSoundCommands,” displays the variation in the increment/decrement at “MakeDisplayCommands,” and outputs the determined value (current continuous value) at “CalculateContinuousValue.”

Next will be described applications where the numerical value input method and input apparatus according to the present invention can be used. The following examples of application are conceivable.

1. If the invention is used to input numerical values for a scroll bar, the searching time can be reduced by interlocking the scroll movement with the scroll bar, scrolling more when the bar is moved fast and scrolling less when the bar is moved more slowly.

2. If the invention is used to input numerical values in a CAD application, it can transmit dialed values to the system in place of the dial unit of the CAD or the like, and make possible revision of contents, such as design data, on that basis.

3. If the invention is used to input numerical values in controlling the brightness or contrast of a display unit, delicate control will be made possible by carrying out the touch operation slowly.

4. If the invention is used to input numerical values in controlling the amplitude or tone or setting the mixer in audio apparatuses, the controlling time can be reducing by accelerating the touch operation.

5. If the invention is used to input numerical values in setting the chronometer time or the like, the fast advancing of time is simplified by accelerating the touch operation.

6. Where the invention is built into a household electrical appliance, such as for setting the temperature of air conditioning, setting of analog values will be simplified.

As is evident from the foregoing description, according to the present invention, by providing a touch input function, for instance, to the display unit of a personal computer executing an application needing the inputting of numerical values and enabling numerical values to be inputted utilizing a virtual dial picture displayed on that display unit, numerical values can be inputted with only the display unit, without using any separate unit of hardware, such as ajog dial or a dial box.

It is to be understood that the embodiments and variations shown and described herein are merely illustrative of the principles of this invention and that various modifications may be implemented by those skilled in the art without departing from the scope and spirit of the invention.

What is claimed is:

1. A method of inputting a numerical value using a touch panel, comprising the steps of:
displaying a virtual input device picture on a display screen with a touch input function; and
displaying said numerical value to be inputted while a pointer is moved in a state of contact on the displayed virtual input device picture, wherein said numerical value is made to vary in relationship to said movement of said pointer.

2. The method of claim 1, wherein said virtual input device picture is a dial.

3. The method of claim 1, wherein the numerical value to be inputted is determined according to a moving distance said pointer is moved on said virtual input device picture.

4. The method of claim 3, wherein said moving distance is determined from a total sum of distances for which the pointer is moved in a state of contact within a certain length of time in the input apparatus area of the displayed virtual input device picture.

5. The method of claim 1, wherein the numerical value to be inputted is determined according to a speed at which the pointer is moved on said virtual input device picture.

6. The method of claim 5, wherein said moving speed is calculated by dividing a total sum of distances for which the pointer is moved in a state of contact within a certain length of time in the input apparatus area of the displayed virtual input device picture by said certain length of time.

7. The method of claim 5, wherein the numerical value to be inputted changes linearly with changes in speed of the pointer.

8. The method of claim 5, wherein the numerical value to be inputted changes non-linearly with changes in speed of the pointer.

9. The method of claim 1, wherein the virtual input device picture displayed on said display screen is configured as a horizontally turning input device picture for inputting in the horizontal direction or a vertically turning input device picture for inputting in the vertical direction or both.

10. The method of claim 1, wherein, during input device operation by moving said pointer in a state of contact on said virtual input device picture, light or sound is emitted according to the operating speed to give the user a feel of operation.

11. The method of claim 1, wherein the display mode of said virtual input device picture is selected out of a constant display mode, an on-demand display mode, and a display mode for automatic activation only when that input is needed.

12. The method of claim 1, wherein said pointer is a finger or a pen.

13. An input apparatus for inputting a numerical value using a touch panel, comprising:
a display unit with a touch input function capable of displaying a virtual input device picture;
a driver for obtaining movement information from positional information obtained from touch input on the display unit; and
a control unit for determining and displaying the numerical value to be inputted according to the movement information obtained by the driver, wherein said control unit varies said numerical value in relationship to said movement of said pointer.

14. The input apparatus, of claim 13, wherein said movement information comprises a movement start position, moving distance, moving speed and moving direction.
